(19) United States
(12) Patent Application Publication
(10) Pub. No.: US 2013/0295430 A1
(43) Pub. Date: Nov. 7, 2013

(54) BATTERY

(71) Applicant: Yoshihide Kurahashi, (US)

(72) Inventor: Tomoyoshi Kurahashi, Tokushima-shi (JP)

(73) Assignee: MITSUBISHI HEAVY INDUSTRIES, LTD., Tokyo (JP)

(21) Appl. No.: 13/813,084

(22) PCT Filed: Sep. 2, 2011
(86) PCT No.: PCT/JP2011/070026

§ 371 Date: Jan. 29, 2013

(30) Foreign Application Priority Data
Sep. 3, 2010 (JP) 2010-198149

(51) Int. Cl. H01M 10/50

(52) U.S. Cl. CPC H01M 10/5004
USPC 429/120

(57) ABSTRACT

A battery of the invention includes an electrode plate, leads (50, 55) that are connected to the electrode plate, external terminals (86, 87) to which the leads (50, 55) are connected, a battery case (80) which stores the electrode plate and the lead (50, 55), and to which the external terminals (86, 87) are fixed through an insulating material, and heat-dissipating bodies (60, 70) that have thermal conductivity and that come into contact with the leads (50, 55) and an inner surface of the battery case (80).

### TECHNICAL FIELD

The present invention relates to a battery including an electrode plate, an external terminal, and a lead that connects the electrode plate and the external terminal.

Priority is claimed on Japanese Patent Application No. 2010-198149, filed Sep. 3, 2010, the content of which is incorporated herein by reference.

### BACKGROUND ART

For example, a lithium ion secondary battery that is disclosed in PTL 1 includes an electrode-stacked body in which positive electrode plates and negative electrode plates are alternately stacked with a separator interposed therebetween.

Each of the positive electrode plates and the negative electrode plates in the electrode-stacked body includes a tab, and the tabs of the positive electrode plates and the tabs of the negative electrode plates are bundled and form tab bundles, respectively. A leading end portion of the positive electrode tab bundle is connected to one end of a positive electrode lead, and the other end portion of the positive electrode lead is connected to a positive electrode terminal. In addition, a leading end portion of the negative electrode tab bundle is connected to one end of a negative electrode lead, and the other end portion of the negative electrode lead is connected to a negative electrode terminal.

### RELATED ART DOCUMENT

### Patent Literature

[PTL 1] Japanese Patent Application Laid-Open No. H11-273638

### DISCLOSURE OF INVENTION

### Problems to be Solved by the Invention

In batteries provided with a lead that connects an electrode plate and an external terminal, including the lithium ion secondary battery disclosed in PTL 1, there is a tendency for excessive heat to be generated at the lead since a current is made to flow to a lead having a limited cross-sectional area. Particularly, like the battery disclosed in PTL 1, in a stacked type battery provided with an electrode-stacked body, since a tab bundle in which tabs of electrode plates are bundled and the lead are connected, an amount of heat that is generated at the lead becomes very large.

In a case where excessive heat is generated in the lead, the electrical resistance thereof increases due to an increase in temperature of the lead and the external terminal that is connected to the lead, and thus battery performance deteriorates. In addition, when heat generation of the lead progresses, in addition to deterioration in battery performance due to thermal contraction of a separator or the like, decomposition of an electrolytic solution is promoted due to the heat that is generated, and thus a problem due to an increase in gas generation amount, and the like, occurs.

Here, an object of the invention is to provide a battery that is capable of increasing the heat dissipation effect of a lead.

### Means for Solving the Problems

An aspect of the present invention is a battery including: a positive electrode plate and a negative electrode plate; a positive electrode lead that is connected to the positive electrode plate; a positive electrode terminal to which the positive electrode lead is connected; a negative electrode lead that is connected to the negative electrode plate; a negative electrode terminal to which the negative electrode lead is connected; a battery case which stores the positive electrode plate, the negative electrode plate, the positive electrode lead, and the negative electrode lead, and to which the positive electrode terminal and the negative electrode terminal are fixed through an insulating material; a positive electrode heat-dissipating body that has thermal conductivity, and that comes into contact with the positive electrode lead and an inner surface of the battery case; and a negative electrode heat-dissipating body that has thermal conductivity, and that comes into contact with the negative electrode lead and the inner surface of the battery case.

According to the above-described configuration, since each of the heat-dissipating bodies comes into contact with the lead and the inner surface of the battery case, heat from the lead may be effectively transmitted to the battery case.

Here, in the above-described invention, one of the positive electrode heat-dissipating body and the negative electrode heat-dissipating body may be formed to have an insulating body that electrically insulates between the lead and the battery case with which the one heat-dissipating body comes into contact, and the other heat-dissipating body of the positive electrode heat-dissipating body and the negative electrode heat-dissipating body may be formed to have a resistive element that serves as an electrical resistor between the lead and the battery case with which the other heat-dissipating body comes in contact, the lead being one of the positive electrode lead and the negative electrode lead, and a conductive body that electrically connects between the lead and the battery case with which the other heat-dissipating body comes into contact. Particularly, it is preferable that at least the inner surface of the battery case is formed from an aluminum-based material, and the inside of the battery case is filled with an electrolyte containing lithium ions, and the one heat-dissipating body is the negative electrode heat-dissipating body, and the other heat-dissipating body is the positive electrode heat-dissipating body.

According to the above-described configuration, the lead and the battery case, with which the other heat-dissipating body comes into contact, can obtain the same electrical potential.

In addition, the battery, which is the aspect of the present invention, may further include a plurality of electrode-stacked bodies that are configured in such a manner that a plurality of the positive electrode plates each having a positive electrode tab, and a plurality of the negative electrode plates each having a negative electrode tab are alternately stacked through a separator, wherein in the electrode-stacked bodies, a positive electrode tab bundle, which is a bundle of the plurality of positive electrode tabs of the electrode-stacked bodies, and the positive electrode lead are connected to each other, and a negative electrode tab bundle, which is a bundle of the plurality of negative electrode tabs of the electrode-stacked bodies, and the negative electrode lead are connected to each other, the plurality of electrode-stacked bodies are stacked in a first direction in which the positive electrode plates and the negative electrode plates of the electrode-stacked bodies are stacked, the positive electrode heat-dissipating body comprises: a positive electrode contact portion, which has a lead contact surface that comes into contact with the positive electrode lead, for each of the plurality of electrode-stacked bodies; and a case contact portion that connects the positive electrode contact portions of the plurality of electrode-stacked bodies to each other and comes into contact with the inner surface of the battery case, and the negative electrode heat-dissipating body comprises: a negative electrode contact portion, which has a lead contact surface that comes into contact with the negative electrode lead, for each of the plurality of electrode-stacked bodies; and a case contact portion that connects the negative electrode contact portions of the plurality of electrode-stacked bodies to each other and comes into contact with the inner surface of the battery case.

In a case of including a plurality of electrode-stacked bodies, according to the above-described configuration, positive electrode heat-dissipating bodies with respect to the plurality of electrode-stacked bodies can be made into one piece, and negative electrode heat-dissipating bodies with respect to the plurality of electrode-stacked bodies can be made into one piece, and thus a handling property of the positive electrode heat-dissipating body and the negative electrode heat-dissipating body can increase during manufacturing the battery. In addition, during a manufacturing process of the battery configured as described above, in the case of including a process of bending the lead, the electrode contact portion for each of the plurality of electrode-stacked bodies can be used as a jig during bending the lead.

In addition, in the above-described invention, the positive electrode contact portion for each of the plurality of electrode-stacked bodies may have a tab contact surface that comes into contact with a base portion of the positive electrode tab bundle of the electrode-stacked body, and the lead contact surface of the positive electrode contact portion may be a surface opposite to the tab contact surface and comes into contact with the positive electrode lead connected to a leading end portion of the positive electrode tab bundle that is bent to one side in the first direction with respect to the base portion of the positive electrode tab bundle, the negative electrode contact portion for each of the plurality of electrode-stacked bodies may have a tab contact surface that comes into contact with a base portion of the negative electrode tab bundle of the electrode-stacked body, and the lead contact surface of the negative electrode contact portion may be a surface opposite to the tab contact surface and comes into contact with the negative electrode lead connected to a leading end portion of the negative electrode tab bundle that is bent to one side in the first direction with respect to the base portion of the negative electrode tab bundle, the thickness, which is a distance between the tab contact surface and the lead contact surface, of the positive electrode contact portion for each of the plurality of electrode-stacked bodies may be larger in the positive electrode contact portion corresponding to the electrode-stacked body locating at an opposite side of the one side than in the positive electrode contact portion corresponding to the electrode-stacked body locating at the one side, and the thickness, which is a distance between the tab contact surface and the lead contact surface, of the negative electrode contact portion for each of the plurality of electrode-stacked bodies may be larger in the negative electrode contact portion corresponding to the electrode-stacked body locating at an opposite side of the one side than in the negative electrode contact portion corresponding to the electrode-stacked body locating at the one side.

In this case, it is preferable that the thickness of the positive electrode contact portion for each of the plurality of electrode-stacked bodies is larger at the positive electrode contact portion corresponding to the electrode-stacked body that is adjacent to the other side of the electrode-stacked body than the positive electrode contact portion corresponding to the electrode-stacked body locating at the one side by a sum of the thickness of the positive electrode lead and the thickness of the positive electrode tab bundle, and the thickness of the negative electrode contact portion for each of the plurality of electrode-stacked bodies is larger at the negative electrode contact portion corresponding to the electrode-stacked body that is adjacent to the other side of the electrode-stacked body than the negative electrode contact portion corresponding to the electrode-stacked body locating at the one side by a sum of the thickness of the negative electrode lead and the thickness of the negative electrode tab bundle.

According to the above-described configuration, the electrode contact portion for each of the electrode-stacked bodies can be used as a jig during bending the lead. In addition, a tab contact portion side of the bent lead becomes approximately parallel with a tab forming end surface of the electrode-stacked body, and even when the tab contact portion comes into contact with the tab bundle formed along the tab forming end surface, it is possible to avoid damage to the tab bundle.

In addition, in the above-described invention, a movement-regulating portion, which regulates relative movement between the positive electrode lead and the positive electrode heat-dissipating body, may be formed in the positive electrode heat-dissipating body, and a movement-regulating portion, which regulates relative movement between the negative electrode lead and the negative electrode heat-dissipating body, may be formed in the negative electrode heat-dissipating body.

In addition, in the above-described invention, the positive electrode heat-dissipating body and the negative electrode heat-dissipating body may form an integral positive and negative electrode heat-dissipating body, and the positive and negative electrode heat-dissipating body may be formed to have an insulating body that electrically insulates between the negative electrode lead and the positive electrode lead with which the positive and negative electrode heat-dissipating body comes into contact.

In addition, in the above-described invention, the positive electrode heat-dissipating body and the negative electrode heat-dissipating body may form an integral positive and negative electrode heat-dissipating body, and the positive and negative electrode heat-dissipating body may be formed to have an electrode contact portion at which the positive electrode contact portion of the positive electrode heat-dissipating body and the negative electrode contact portion of the negative electrode heat-dissipating body are connected to each other, a common case contact portion integrating the case contact portion of the positive electrode heat-dissipating body and the case contact portion of the negative electrode heat-dissipating body, and an insulating body that electrically insulates between the negative electrode lead and the positive electrode lead with which the positive and negative electrode of the heat-dissipating body comes into contact.

In the case of including the positive and negative electrode heat-dissipating body, a movement-regulating portion, which regulates relative movement between the positive electrode lead and the negative electrode lead, may be formed in the positive and negative electrode heat-dissipating body

### Advantageous Effects of Invention

According to the invention, since each heat-dissipating body comes into contact with the lead and the inner surface of the battery case, heat from the lead may be effectively transmitted to the battery case. Therefore, according to the invention, a heat dissipation effect of the lead may be increased.

### BRIEF DESCRIPTION OF DRAWINGS

FIG. 1 is a main section cut-away perspective view of a battery according to a first embodiment of the invention.

FIG. 2 is a developed perspective view of the battery according to the first embodiment of the invention.

FIG. 3 is a developed perspective view of an electrode-stacked body according to the first embodiment of the invention.

FIG. 4 is a main section perspective view of a lead-bending device according to the first embodiment of the invention.

FIG. 5 is a main section cut-away side view of the lead-bending device according to the first embodiment of the invention.

FIG. 6 is a main section side view of the electrode-stacked body and the lead according to the first embodiment of the invention.

FIG. 7 is a view illustrating a lead-bending method according to a reference example.

FIG. 8 is a main portion side view of an electrode-stacked body and a lead according to the reference example.

FIG. 9 is a schematic view of the inside of the battery according to the first embodiment of the invention.

FIG. 10 is a developed perspective view of a battery according to a second embodiment of the invention.

FIG. 11 is a schematic view of the inside of the battery according to the second embodiment of the invention.

FIG. 12 is a schematic view of the inside of the battery according to a modification example of the second embodiment of the invention.

### BEST MODE FOR CARRYING OUT THE INVENTION

Hereinafter, batteries as various embodiments according to the invention will be described.

### First Embodiment

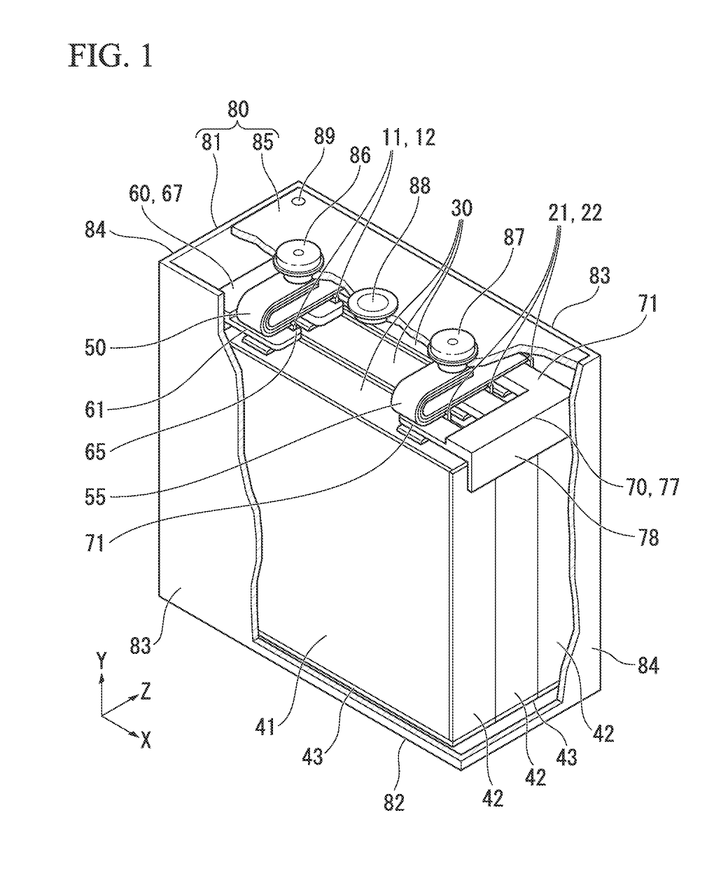

A battery as a first embodiment according to the present invention will be described with reference to FIGS. 1 to 9.

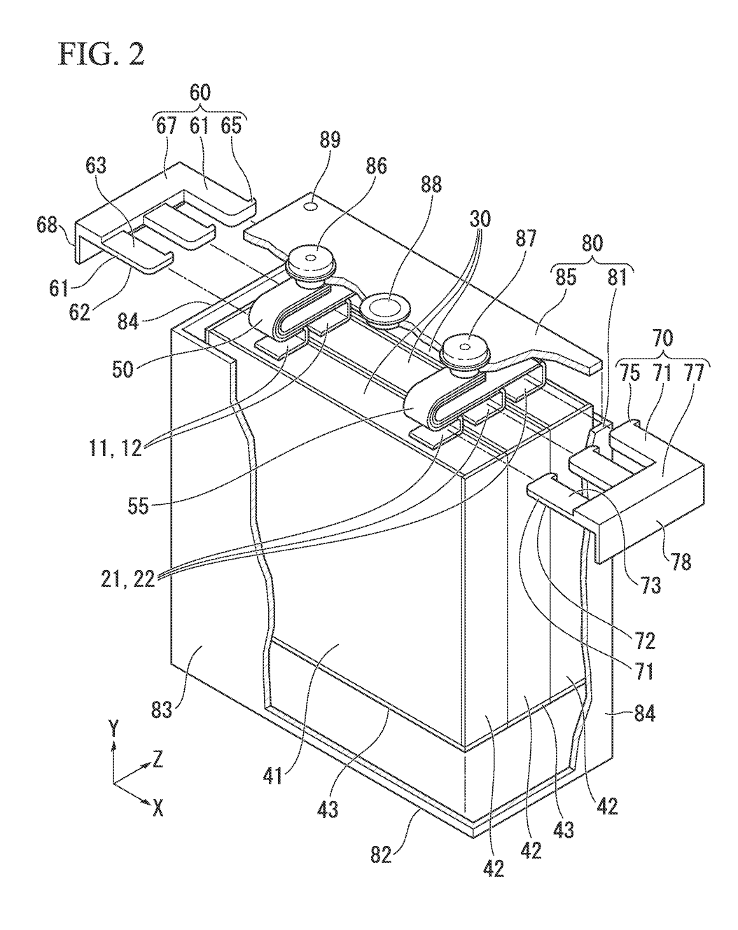

The battery according to this embodiment is, for example, a lithium ion secondary battery. As shown in FIGS. 1 and 2, the battery includes electrode-stacked bodies 30 in which positive electrode plates and negative electrode plates are stacked, cover plates 41, 42, and 43 that cover the outer circumferential surface of the electrode-stacked bodies 30, a positive electrode lead 50 that is connected to the positive electrode plates of the electrode-stacked bodies 30, a negative electrode lead 55 that is connected to the negative electrode plates of the electrode-stacked bodies 30, a positive electrode heat-dissipating body 60 that comes into contact with the positive electrode lead 50, a negative electrode heat-dissipating body 70 that comes into contact with the negative electrode lead 55, a battery case 80 that stores these, a positive electrode terminal 86 that is connected to the positive electrode lead 50, a negative electrode terminal 87 that is connected to the negative electrode lead 55, and a safety valve 88 that operates when a pressure inside the battery case 80 reaches a predetermined pressure or more.

The battery case 80 includes a case main body 81 in which a storage concave portion to store the electrode-stacked bodies 30 and the like is formed, and a lid 85 that closes a rectangular opening of the case main body 81. All of the case main body 81 and the lid 85 are formed from an aluminum alloy, for example, an A3000-based aluminum alloy, an A1500-based aluminum alloy, or the like. The positive electrode terminal 86 and the negative electrode terminal 87 are fixed to the lid 85 through an insulating material. In addition, the safety valve 88 is fixed to the lid 85 at a position between the positive electrode terminal 86 and the negative electrode terminal 87.

Here, as a matter of convenience of the following description, the direction in which the positive electrode plates and the negative electrode plate are alternately stacked is set as the Z direction (a first direction), a direction which is orthogonal to the Z direction and in which the positive electrode terminal 86 and negative electrode terminal 87 are present with the electrode-stacked bodies 30 taken as a reference is set as the Y direction, and a direction that is orthogonal to the Z direction and the Y direction is set as the X direction.

The case main body 81 has a pair of first rectangular side plates 83 that are opposite to each other in the Z direction, a pair of second rectangular side plates 84 that are opposite to each other in the X direction, and a bottom plate 82 that is joined to (−)Y sides of the first side plates 83 and the second side plates 84.

The lid 85 of the battery case 80 is formed in a rectangular plate shape. The positive electrode terminal 86, the safety valve 88, and the negative electrode terminal 87 are fixed to the lid 85 in this order in parallel with the X direction.

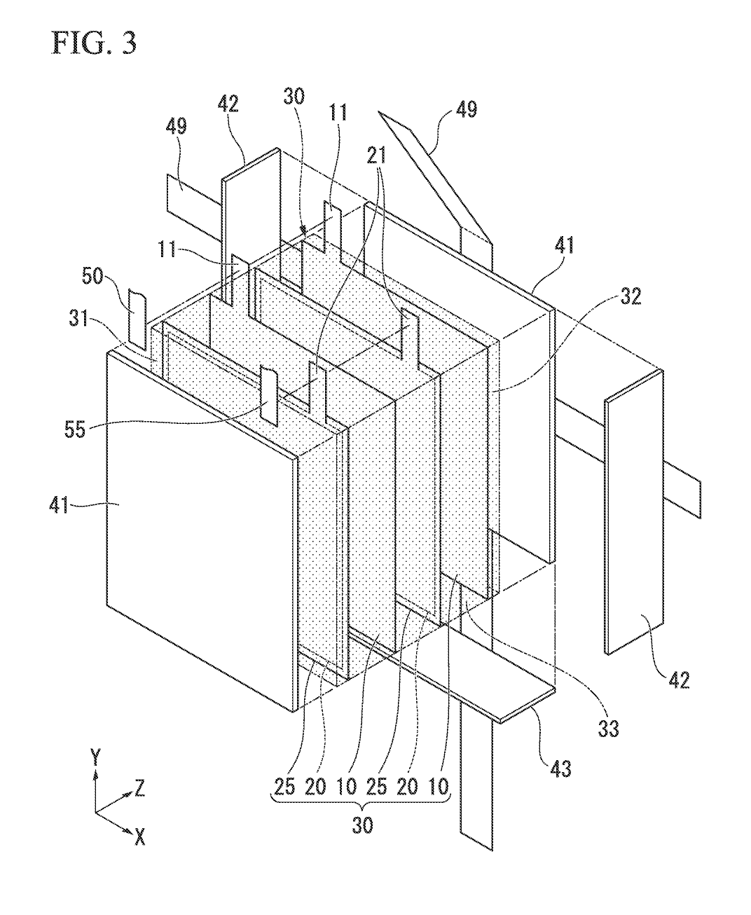

As shown in FIG. 3, each of the electrode-stacked bodies 30 is configured in such a manner that positive electrode plates 10 and negative electrode plates 20 that are covered with a separator 25 are alternately stacked.

Each of the positive electrode plates 10 is formed by applying a positive electrode active material onto an approximately rectangular current-collecting plate. In addition, each of the negative electrode plates 20 is formed by applying a negative electrode active material onto an approximately rectangular current-collecting plate. At a portion of an outer edge of each of the current-collecting plates, tabs 11 and 21 are formed to protrude therefrom, and an active material is not applied to the tabs 11 and 21.

A portion of the negative electrode plate 20 excluding the negative electrode tab 21 is covered with a separator 25. The separator 25 is formed from a porous insulating resin such as propylene and polyethylene.

The positive electrode plates 10, and the negative electrode plates 20 that are covered with the separator 25 are alternately stacked as described above and make up each of the electrode-stacked bodies 30 having an approximately rectangular parallelepiped shape. When constructing the electrode-stacked bodies 30, a direction of each of the positive electrode plates 10 is arranged in such a manner that each of the positive electrode tabs 11 faces the (+)Y side and is positioned on the (−)X side, and a direction of each of the negative electrode plates 20 is arranged in such a manner that each of the negative electrode tabs 21 faces the (+)Y side and is positioned on the (+)X side.

Each of the electrode-stacked bodies 30 having an approximately rectangular parallelepiped shape has a pair of first side surfaces 31 that are opposite to each other in the Z direction, a pair of second side surfaces 32 that are opposite to each other in the X direction, and a pair of end surfaces 33 that are opposite to each other in the Y direction. In addition, all of the above-described surfaces 31, 32, and 33 have an approximately rectangular shape, respectively.

As the cover plates 41, 42, and 43, there are a pair of first cover plates 41 that come into contact with the pair of first side surfaces 31 of each of the electrode-stacked bodies 30, a pair of second cover plates 42 that come into contact with the pair of second side surfaces 32 of each of the electrode-stacked bodies 30, and a third cover plate 43 comes into contact with the (−)Y side end surface 33, that is, the end surface 33 on which the tabs 11 and 21 are not formed, in a pair of end surfaces 33 of each of the electrode-stacked bodies 30.

Each of the cover plates 41, 42, and 43 has substantially the same shape and the same size as each of the surfaces 31, 32, and 33, with which each of the cover plates 41, 42, and 43 comes into contact, of the electrode-stacked body 30. Each of the cover plates 41, 42, and 43 is formed from a porous insulating resin such as propylene and polyethylene. All of the respective cover plates 41, 42, and 43 have the predetermined thickness or more, and have a relatively high rigidity.

The respective cover plates 41, 42, and 43 are lashed down by a tab 49 that is formed from a porous insulating resin such as propylene and polyethylene after being brought into contact with the respective corresponding surfaces 31, 32, and 33 of the electrode-stacked body 30, and thus the electrode-stacked body 30 and the respective cover plates 41, 42, and 43 become an integral block. As described above, in this embodiment, since approximately the entirety of a side peripheral surface of the electrode-stacked body 30 in the block is covered with the cover plates 41, 42, and 43 that have rigidity, as long as none of the cover plates 41, 42, and 43 are out of place, mutual misalignment of the plurality of electrode plates 10 and 20 that make up the electrode-stacked body 30 does not occur.

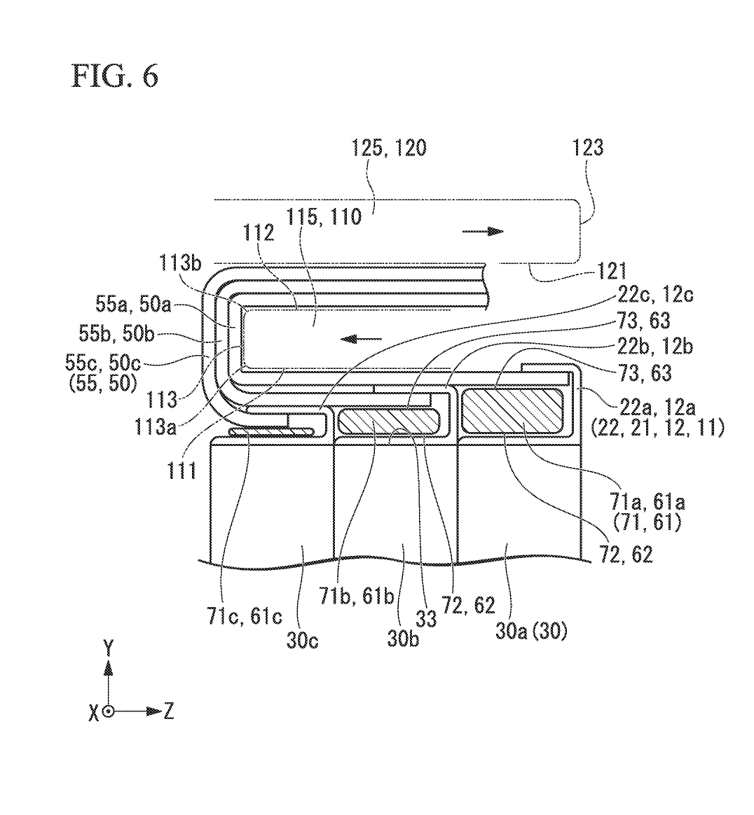

As shown in FIG. 6, the respective positive electrode tabs 11 of the positive electrode plates 10 are collected on the (+)Z side and are bundled as a positive electrode tab bundle 12. In addition, the respective negative electrode tabs 21 of the negative electrode plates 20 are also collected on the (+)Z side, and are bundled as a negative electrode tab bundle 22. Each of the tab bundles 12 and 22 is connected to each of the external terminals 86 and 87 that are fixed to the battery case 80 (FIG. 1) by each of the leads 50 and 55 for each of the tab bundles 12 and 22.

All of the leads 50 and 55 extend from tab connection portions thereof in the (−)Z direction and then are bent in the (+)Z direction, respectively, and thus the leading end portions thereof are connected to the external terminals 86 and 87 (FIG. 1) by a screw or the like.

As shown in FIGS. 1 and 2, the electrode-stacked bodies 30 are stored in the battery case 80 in a state in which a side at which the tab bundles 12 and 22 are present faces the (+)Y side and the electrode-stacked bodies 30 overlap each other in the Z direction.

At this time, among the cover plates 41, 42, and 43 that cover each of the electrode-stacked bodies 30, the cover plate 41 is opposite to the first side plate 83 of the battery case main body 81, the cover plate 42 is opposite to the second side plate 84 of the battery case main body 81, and the cover plate 43 is opposite to the bottom plate 82 of the battery case main body 81.

As shown in FIG. 2, the positive electrode heat-dissipating body 60 includes a positive electrode contact portion 61 that is present for each of the electrode-stacked bodies 30, a movement-regulating portion 65 that is provided at one side end of each positive electrode contact portion 61, and a case contact portion 67 that connects the other side ends of respective positive electrode contact portions 61 to each other and comes into contact with an inner surface of the battery case main body 81.

The case contact portion 67 of the positive electrode heat-dissipating body 60 has a case contact surface 68 that comes into contact with the second side plate 84, which is positioned on the (−)X side, of the battery case main body 81.

Each positive electrode contact portion 61 has a pair of surfaces 62 and 63 that extend from the case contact portion 67 in the (+)X direction, and are orthogonal to the Y direction. In the pair of surfaces 62 and 63, a surface that faces the (−)Y side makes up a tab contact surface 62 that comes into contact with the positive electrode tab bundle 12, and a surface that faces the (+)Y side makes up a lead contact surface 63 that comes into contact with the positive electrode lead 50 that is connected to the positive electrode tab bundle 12.

Each movement-regulating portion 65 of the positive electrode heat-dissipating body 60 protrudes from the (+)X side end of each positive electrode contact portion 61 in the (+)Z direction. The movement-regulating portion 65 forms a hook shape, on which the positive electrode tab bundle 12 is hooked, in cooperation with the positive electrode contact portion 61 that extends in the X direction.

The negative electrode heat-dissipating body 70 includes a negative electrode contact portion 71 that is present for each of the electrode-stacked bodies 30, a movement-regulating portion 75 that is provided at one side end of each negative electrode contact portion 71, and a case contact portion 77 that connects the other side ends of the respective negative electrode contact portions 71 to each other and comes into contact with the inner surface of the battery case main body 81.

The case contact portion 77 of the negative electrode heat-dissipating body 70 has a case contact surface 78 that comes into contact with the second side plate 84, which is positioned on the (+)X side, of the battery case main body 81.

Each negative electrode contact portion 71 has a pair of surfaces 72 and 73 that extend from the case contact portion 77 in the (−)X direction, and are orthogonal to the Y direction. In the pair of surfaces 72 and 73, a surface that faces the (−)Y side makes up a tab contact surface 72 that comes into contact with the negative electrode tab bundle 22, and a surface that faces the (+)Y side makes up a lead contact surface 73 that comes into contact with the negative electrode lead 55 that is connected to the negative electrode tab bundle 22.

Each movement-regulating portion 75 of the negative electrode heat-dissipating body 70 protrudes from the (−)X side end of each negative electrode contact portion 71 in the (+)Z direction. The movement-regulating portion 75 forms a hook shape, on which the negative electrode tab bundle 22 is hooked, in cooperation with the negative electrode contact portion 71 that extends in the X direction.

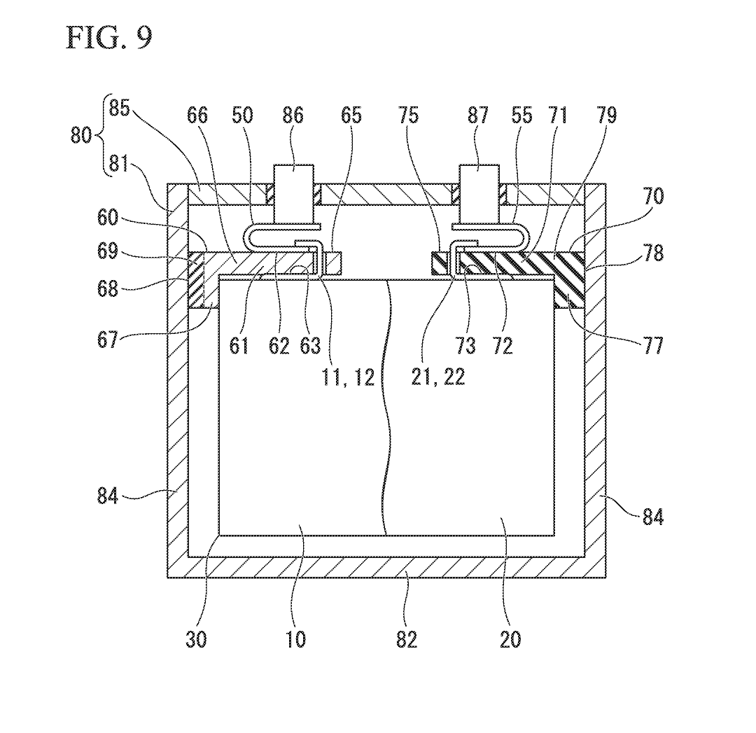

As shown in FIG. 9, each positive electrode contact portion 61 and each movement-regulating portion 65 of the positive electrode heat-dissipating body 60 are formed from a conductive body 66 having high thermal conductivity, and in the case contact portion 67 of the positive electrode heat-dissipating body 60, a portion including the case contact surface 68 is formed from a resistive element 69 having high thermal conductivity. In addition, the negative electrode heat-dissipating body 70 is formed from an insulating body 79 having high thermal conductivity. As a conductive material having high thermal conductivity, for example, an aluminum alloy may be exemplified. In addition, as an insulating material having high thermal conductivity, for example, aluminum nitride may be exemplified. In addition, FIG. 9 shows a schematic view of the inside of the battery.

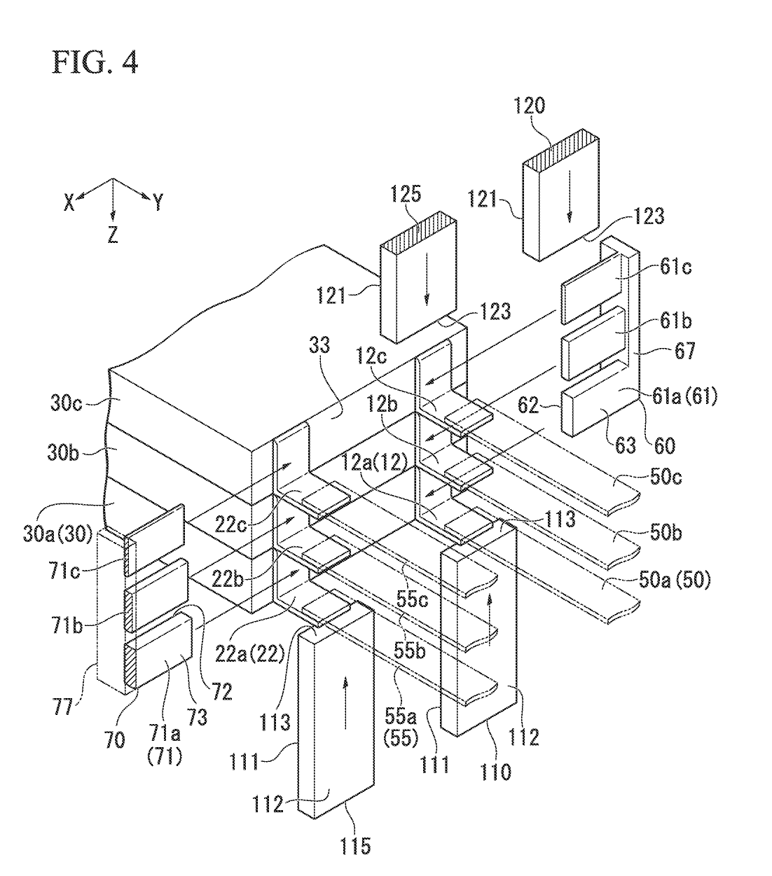

Next, a lead-bending device that bends a lead that is connected to a tab bundle and a method of bending the lead using the lead-bending device will be described with reference to FIGS. 4 to 6. In addition, for convenience of the following description, among the electrode-stacked bodies 30, an electrode-stacked body that is positioned furthest to the (+)Z side is set as an electrode-stacked body 30a, an electrode-stacked body that is adjacent to the (−)Z side of the electrode-stacked body 30a is set as an electrode-stacked body 30b, and an electrode-stacked body that is adjacent to the (−)Z side of the electrode-stacked body 30b is set as an electrode-stacked body 30c. In addition, the tab bundles 12 and 22 of each of the electrode-stacked bodies 30a, 30b, and 30c are set as 12a, 22a, 12b, 22b, 12c, and 22c, and the leads 50 and 55 that are connected to respective tab bundles 12a, 22a, 12b, 22b, 12c, and 22c are set as leads 50a, 55a, 50b, 55b, 50c, and 55c. In addition, In FIGS. 4 to 6, for easy understanding of a relationship between the respective electrode-stacked bodies 30a, 30b, and 30c, and the positive electrode tab bundles 12a, 12b, and 12c, and the negative electrode tab bundles 22a, 22b, and 22c with respect to the respective electrode-stacked bodies 30a, 30b, and 30c, the cover plate is omitted.

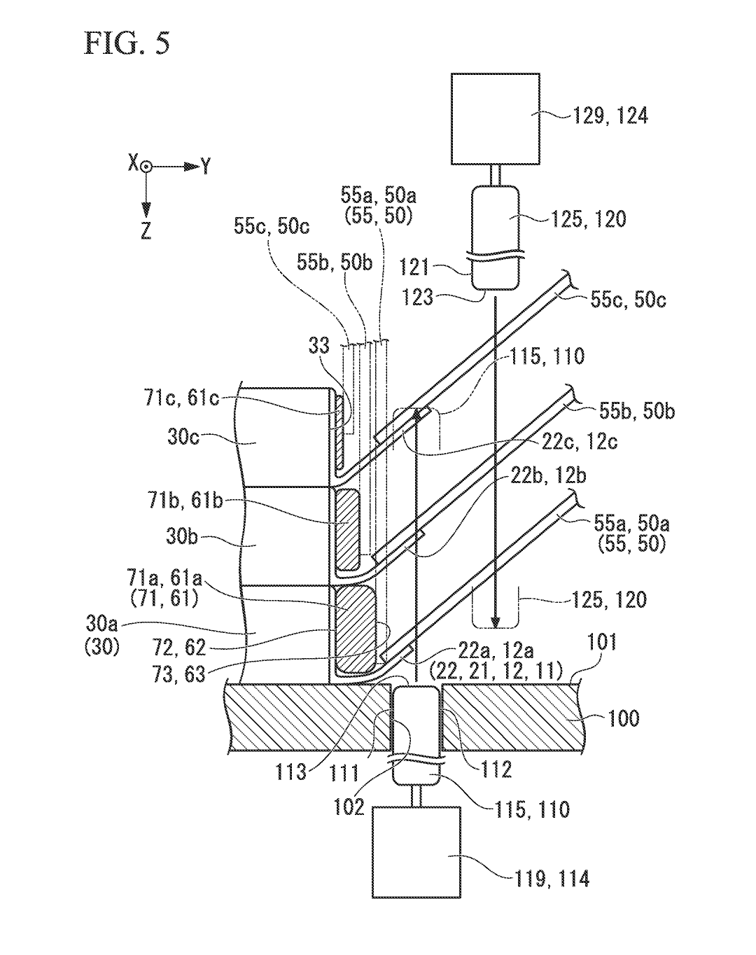

As shown in FIGS. 4 and 5, the lead-bending device of this embodiment includes a table 100 having a mounting surface 101 that is orthogonal to the Z direction, a negative electrode heat-dissipating body driving mechanism (not shown) that grasps the negative electrode heat-dissipating body 70 and makes it advance or retreat in the (−)X direction, a positive electrode heat-dissipating body driving mechanism (not shown) that grasps the positive electrode heat-dissipating body 60 and makes it advance or retreat in the (+)X direction, a negative electrode lead-pressing jig 115 that presses the negative electrode leads 55a, 55b, and 55c that are connected to negative electrode tab bundle 22a, 22b, and 22c, respectively, a negative electrode lead-pressing-driving mechanism 119 that makes the negative electrode lead-pressing jig 115 advance or retreat in the (−)Z direction, a positive electrode lead-pressing jig 110 that presses the positive electrode leads 50a, 50b, and 50c that are connected to the positive electrode tab bundles 11a, 11b, and 11c, respectively, a positive electrode lead-pressing-driving mechanism 114 that makes the positive electrode lead-pressing jig 110 advance or retreat in the (−)Z direction, a negative electrode lead-bending jig 125 that bends each of the negative electrode leads 55a, 55b, and 55c that are pressed by the negative electrode lead-pressing jig 115, a negative electrode lead-bending-driving mechanism 129 that makes the negative electrode lead-bending jig 125 advance or retreat in the (+)Z direction, a positive electrode lead-bending jig 120 that bends the respective positive electrode leads 50a, 50b, and 50c that are pressed by the positive electrode lead-pressing jig 110, and a positive electrode lead-bending-driving mechanism 124 that makes the positive electrode lead-bending jig 120 advance or retreat in the (+)Z direction. In addition, in FIG. 4, the movement-regulating portion 65 of the positive electrode heat-dissipating body 60, the movement-regulating portion 75 of the negative electrode heat-dissipating body 70, and the like are omitted, and the positive electrode heat-dissipating body 60 and the negative electrode heat-dissipating body 70 are drawn in a simple manner.

The electrode-stacked bodies 30a, 30b, and 30c are mounted on the mounting surface 101 in a state in which the overlapping direction thereof becomes orthogonal with respect to the mounting surface 101 of the table 100. At this time, in the surfaces of each of the electrode-stacked bodies 30, the tab forming end surface 33 on a side at which a tab bundle is present is orthogonal to the Y direction and faces the (+)Y side in accordance with the above-described assumption, and it is assumed that a side at which each of the tabs is collected is the (+)Z side, and the positive electrode tab bundle 12 is positioned at the (−)X side with respect to the negative electrode tab bundle 22.

The negative electrode heat-dissipating body 70 advances or retreats between the (+)X side retreated position and the (−)X side advanced position by the negative electrode heat-dissipating body driving mechanism (not shown). Each of negative electrode contact portions 71a, 71b, and 71c of the negative electrode heat-dissipating body 70 at the retreated position is disposed on the (+)X side in the X direction, in relation to the negative electrode tab bundle 22 of each of the electrode-stacked bodies 30a, 30b, and 30c on the table 100. In addition, each of the negative electrode contact portions 71a, 71b, and 71c of the negative electrode heat-dissipating body 70 is disposed at substantially the same position as each of corresponding electrode-stacked bodies 30a, 30b, and 30c in the Z direction.

The positive electrode heat-dissipating body 60 advances or retreats between the (−)X side retreated position and the (+)X side advanced position by the positive electrode heat-dissipating body driving mechanism (not shown). Each of the positive electrode contact portions 61a, 61b, and 61c of the positive electrode heat-dissipating body 60 at the retreated position is disposed on the (−)X side in the X direction, in relation to the positive electrode tab bundle 12 of each of the electrode-stacked bodies 30a, 30b, and 30c on the table 100. In addition, each of the negative electrode contact portions 71a, 71b, and 71c of the negative electrode heat-dissipating body 70 is disposed at substantially the same position as each of corresponding electrode-stacked bodies 30a, 30b, and 30c in the Z direction.

In regard to the thickness that is a distance between the tab contact surface 72 and the lead contact surface 73 of each of the negative electrode contact portions 71a, 71b, and 71c of the negative electrode heat-dissipating body 70, compared to the negative electrode contact portion 71c on the (−)Z side, another negative electrode contact portion 71b that is adjacent to the negative electrode contact portion 71c from the (+)Z side is thicker by the sum of the thickness of the negative electrode tab bundle 22 and the thickness of the negative electrode lead 55.

In addition, in regard to the thickness that is the distance between the tab contact surface 62 and the lead contact surface 63 of each of the positive electrode contact portions 61a, 61b, and 61c of the positive electrode heat-dissipating body 60, compared to the positive electrode contact portion 61c on the (−)Z side, another positive electrode contact portion 61b that is adjacent to the positive electrode contact portion 61c from the (+)Z side is thicker by the sum of the thickness of the positive electrode tab bundle 12 and the thickness of the positive electrode lead 50.

The negative electrode heat-dissipating body driving mechanism (not shown) makes the negative electrode heat-dissipating body 70 at a retreated position moves in the (−)X direction and brings the tab contact surface 72 of each of the tab contact portions 71a, 71b, and 71c of the negative electrode heat-dissipating body 70 into contact with each of the negative electrode tab bundles 22a, 22b, and 22c. In addition, the positive electrode heat-dissipating body driving mechanism (not shown) makes the positive electrode heat-dissipating body 60 at a retreated position moves in the (+)X direction and brings the tab contact surface 62 of each of the tab contact portions 61a, 61b, and 61c of the positive electrode heat-dissipating body 60 into contact with each of the positive electrode tab bundles 12a, 12b, and 12c.

Each of the lead-pressing jigs 110 and 115 has a pair of surfaces that are orthogonal to the Y direction. In the pairs of surfaces, the (−)Y side surface makes up a first lead contact surface 111 and the (+)Y side surface makes up a second lead contact surface 112.

Each of the lead-pressing jigs 110 and 115 advances or retreats between the (+)Z side retreated position and the (−)Z side advanced position by each of the lead-pressing-driving mechanisms 114 and 119. All of the lead-pressing jigs 110 and 115 at the retreated position are positioned on the (+)Z side in the Z direction in relation to each of the electrode-stacked bodies 30a, 30b, and 30c on the table 100. Therefore, an opening 102 (FIG. 5) through which the lead-pressing jig 110 or 115 at the retreated position freely appears is formed in the table 100.

The negative electrode lead-pressing jig 115 is disposed on the (+)Y side in the Y direction in relation to the negative electrode contact portion 71a furthest to the (+)Z side, that is, the thickest negative electrode contact portion 71a, and is disposed at substantially the same position as each of the negative electrode lead bundles 22a, 22b, and 22c in the X direction. In addition, the positive electrode lead-pressing jig 110 is disposed on the (+)Y side in the Y direction in relation to the positive electrode contact portion 61a furthest to the (+)Z side, that is, the thickest positive electrode contact portion 61a and is disposed at substantially the same position as each of the positive electrode tab bundles 12a, 12b, and 12c in the X direction.

All of the lead-pressing-driving mechanisms 114 and 119 for each of the lead-pressing jigs 110 and 115 make the lead-pressing jigs 110 and 115 at a retreated position move in the (−)Z direction, and bring the first lead contact surfaces 111 and 111 of the lead-pressing jigs 110 and 115 into contact with the leads 50a and 55a furthest to the (+)Z side, respectively. As a result thereof, the leads 50a and 55a are sandwiched between the lead contact surfaces 63 and 73 of the furthest (+)Z side positive electrode contact portion 61a and the negative electrode contact portion 71a of the heat-dissipating bodies 60 and 70, and the first lead contact surfaces 111 and 111 of the lead-pressing jigs 110 and 115, respectively, and are pressed in parallel with the lead contact surfaces 63 and 73 of the furthest (+)Z side positive electrode contact portion 61a and the negative electrode contact portion 71a of the heat-dissipating bodies 60 and 70, respectively.

During this process, the lead 50b, 50c, 55b, and 55c, which are positioned on the (−)Z side in relation to the leads 50a and 55a furthest to the (+)Z side, are pressed by a lead on the (+)Z side, come into contact with corresponding positive electrode contact portions 61b and 61c, and corresponding negative electrode contact portions 71b and 71c of the heat-dissipating bodies 60 and 70, and are pressed in parallel with corresponding lead contact surfaces, respectively. That is, all of the respective leads 50 and 55 enter a state of extending from the connection portions with the tab bundles 12 and 22 in the (−)Z direction that is an advancing direction of the lead-pressing jigs 110 and 115.

As described above, during a lead-bending process, each of the heat-dissipating bodies 60 and 70 serves as a jig for pressing each of the tab bundles 12 and 13 in the (−)Y side and for holding a tab connection side of each of the leads 50 and 55 with each of the lead-pressing jigs 110 and 115 in between.

Each of the lead-bending jigs 120 and 125 has a pair of surfaces that are orthogonal to the Y direction, and in the pair of surfaces, the (−)Y side surface makes up the lead contact surface 121.

Each of the lead-bending jigs 120 and 125 advances or retreats between the (−)Z side retreated position and the (+)Z side advanced position by the lead-bending-driving mechanisms 124 and 129, respectively. All of the lead-bending jigs 120 and 125 at the retreated position are disposed on the (−)Z side in the Z direction in relation to the plurality of the electrode-stacked bodies 30a, 30b, and 30c on the table 100.

The negative electrode lead-bending jig 125 is disposed on the (+)Y side in the Y direction in relation to the negative electrode lead-pressing jig 115, and is disposed at substantially the same position as each negative electrode tab bundle 22 in the X direction. In addition, the positive electrode lead-bending jig 120 is disposed on the (+)Y side in the Y direction in relation to the positive electrode lead-pressing jig 110, and is disposed at substantially the same position as each positive electrode tab bundle 12 in the X direction.

The lead-bending-driving mechanisms 124 and 129 for the lead-bending jigs 120 and 125 make the lead-bending jigs 120 and 125 at the retreated position advance in the (+)Z direction, respectively. At this time, an operator or the like slightly bends leading end sides of the respective leads 50 and 55, which are pressed by the lead-pressing jigs 110 and 115 and extend in the (+)Z direction, in the (+)Y side, and makes the leading end sides of the leads 50 and 55 face the lead-bending jigs 120 and 125, respectively. When the respective leads 50 and 55 enter this state, the lead-bending-driving mechanisms 124 and 129 make the lead-bending jigs 120 and 125 at the retreated position advance in the (+)Z, respectively, as described above. During this process, (+)Z side leading end surfaces 123 of the respective lead-bending jigs 120 and 125 come into contact with leading end sides of the leads 50c and 55c furthest to the (−)Z sides, and presses the leading end sides of the leads 50 and 55 to the (+)Z side, respectively.

When the leading end sides of the leads 50 and 55 are pressed to the (+)Z side, respectively, as shown in FIG. 6, the leads 50 and 55 are bent in correspondence with an angle 113a made by the first lead contact surface 111 and the (+)Z side leading end surface 113 and an angle 113b made by the leading end surface 113 and the second lead contact surface 112 of the lead-pressing jigs 110 and 115, respectively.

Finally, at a point of time when the lead-bending jigs 120 and 125 are located at the advanced position, the leading end sides' furthest (+)Z side leads 50a and 55a come into contact with the (−)Z side leading end surfaces 113 of the lead-pressing jigs 110 and 115 and the second lead contact surfaces 112 of the lead-pressing jigs 110 and 115, respectively, while tab connection portion sides of the leads 50a and 55a are maintained in a state of being brought into contact with the first lead contact surfaces 111 of the lead-pressing jigs 110 and 115, respectively, as described above, whereby the leads 50a and 55a furthest to the (+)Z side are shaped into a lateral U shape. Similarly, other leads 50b, 50c, 55b, and 55c are also shaped into a lateral U shape, and thus the lead contact surfaces 121 of the lead-bending jigs 120 and 125 come into contact with the leads 50c and 55c furthest to the (−)Z side, respectively.

As a result, all of the tab connection sides of the leads 50 and 55 enter a state of extending in the (−)Z direction that is an advancing direction of the lead-pressing jigs 110 and 115, respectively, and all of the leading end sides of the leads enter a state of extending in the (+)Z direction that is the advancing direction of the lead-bending jigs 120 and 125, respectively, whereby the respective leads 50 and 55 are bent to a target lateral U shape.

When the respective leads 50 and 55 are bent into the lateral U shape, the lead-pressing jigs 110 and 115 and the lead-bending jigs 120 and 125 are made to retreat. In addition, the heat-dissipating bodies 60 and 70 are maintained at a state of being brought into contact with the tab bundles 12 and 22 and the leads 50 and 55, respectively. In addition, leading end portions of the plurality of positive electrode leads 50a, 50b, and 50c, which are connected to the electrode-stacked bodies 30a, 30b, and 30c, respectively, are connected to the positive electrode terminal 86, which is fixed to the lead 85 of the battery case 80, with a screw or the like as described above. In addition, leading end portions of the negative electrode leads 55a, 55b, and 55c, which are connected to the electrode-stacked bodies 30a, 30b, and 30c, respectively, are connected to the negative electrode terminal 87 that is fixed to the lid 85 of the battery case 80 with a screw or the like.

When the process of connecting the leads 50 and 55 and the external terminals 86 and 87, respectively, is terminated, as shown in FIGS. 1 and 2, the electrode-stacked bodies 30 and the respective heat-dissipating bodies 60 and 70 are put into the battery case main body 81. At this time, as described above, the electrode contact portions 61 and 71 of the respective heat-dissipating bodies 60 and 70 enter a state in which the tab contact surfaces 62 and 72 come into contact with the tab bundles 12 and 22 of the electrode-stacked bodies 30, respectively, and the lead contact surfaces 63 and 73 come into contact with the leads 50 and 55 that are connected to the tab bundles 12 and 22, respectively, that is, a state immediately after the bending of the respective leads 50 and 55 is terminated.

After the process of connecting the leads 50 and 55 and the external terminals 86 and 87, respectively, is terminated, since until the electrode-stacked bodies 30a, 30b, and 30c and the respective heat-dissipating bodies 60 and 70 are put into the battery case main body 81, the relative movement of the heat-dissipating bodies 60 and 70 with respect to the leads 50 and 55 is regulated by the movement-regulating portions 65 and 75 and the like, respectively, the respective heat-dissipating bodies 60 and 70 are not likely to be out of place from the electrode-stacked bodies 30a, 30b, and 30c. Therefore, in this embodiment, during the process, it is easy to handle the electrode-stacked bodies 30a, 30b, and 30c, and the respective heat-dissipating bodies 60 and 70.

When the electrode-stacked bodies 30a, 30b, and 30c, and the respective heat-dissipating bodies 60 and 70 are completely put into the battery case main body 81, the case contact portions 67 and 77 of the heat-dissipating bodies 60 and 70 come into contact with the inner surfaces of the second side plates 84 and 84 of the case main body 81, respectively. In addition, in order for the case contact portions 67 and 77 of the heat-dissipating bodies 60 and 70 to reliably come into contact with the second side plates 84 and 84 of the case main body 81, respectively, an insulating spacer or the like that slightly broadens the gap between the positive electrode heat-dissipating body 60 and negative electrode heat-dissipating body 70 may be provided therebetween.

When the electrode-stacked bodies 30 and the respective heat-dissipating bodies 60 and 70 are put into the battery case main body 81, the boundary of the case main body 81 and the lid 85 is welded to adjoin both of these. In addition, an electrolytic solution containing lithium ions is injected to the inside of the battery case 80 from an injection port 89 of the lid 85 and then the injection port 89 is sealed.

A single battery is completed as described above.

Hereinbefore, in this embodiment, as shown in FIGS. 1 and 9, since the positive electrode heat-dissipating body 60 having high thermal conductivity comes into contact with the positive electrode lead 50 and the positive electrode tab bundle 12, and comes into contact with the inner surface of the battery case main body 81, heat from the positive electrode lead 50 and the positive electrode tab bundle 12 can be effectively transmitted to the battery case main body 81. In addition, since the negative electrode heat-dissipating body 70 having high thermal conductivity comes into contact with the negative electrode lead 55 and negative electrode tab bundle 22, and comes into the inner surface of the battery case main body 81, heat from the negative electrode lead 55 and the negative electrode tab bundle 22 can be effectively transmitted to the battery case main body 81. Therefore, according to this embodiment, a heat dissipation effect of the respective leads 50 and 55 and the tab bundles 12 and 22 can be increased, and thus excessive heat generation thereof can be prevented from occurring.

In addition, in this embodiment, as described above, as a jig during bending the respective leads 50 and 55, the heat-dissipating bodies 60 and 70 can be used, respectively, and thus the cost for preparing a separate jig can be reduced.

Furthermore, according to this embodiment, reaction between the battery case 80 formed from an aluminum alloy and the lithium ions in the electrolytic solution can be avoided, and thus deterioration of the battery case 80 and a decrease in battery performance can be prevented. In this embodiment, as shown in FIG. 9, since the positive electrode heat-dissipating body 60 is formed to have the resistive element 69, a current that flows to the positive electrode lead 50 that comes into contact with the positive electrode heat-dissipating body 60 can be prevented from flowing into the battery case 80 through the positive electrode heat-dissipating body 60, and the positive electrode lead 50 and the battery case 80 can have substantially the same electrical potential. The reaction between the battery case 80 that is formed from an aluminum alloy and the lithium ions in the electrolytic solution progresses in an electrochemical manner under a reducing atmosphere. On the other hand, in this embodiment, since positive electrode lead 50 and the battery case 80 have substantially the same electrical potential, the inner surface of the battery case 80 enters an acidic atmosphere state, and the reaction between the battery case 80 that is formed from an aluminum alloy and the lithium ions in the electrolytic solution does not occur.

In addition, the negative electrode heat-dissipating body 70 comes into contact with the negative electrode lead 55 and the negative electrode tab bundle 22, and also comes into contact with the inner surface of the battery case main body 81. However, since the entirety of the negative electrode heat-dissipating body 70 is formed from the insulating body 79, a current that flows to the negative electrode lead 55 and the negative electrode tab 22 does not flow to the battery case 80 through the negative electrode heat-dissipating body 70.

Here, in this embodiment, the entirety of the negative electrode heat-dissipating body 70 is formed from the insulating body 79, but the negative electrode heat-dissipating body may be configured in such a manner that the main body of the entirety of the negative electrode heat-dissipating body is formed from a conductive material, and the main body is coated with an insulating material. That is, the negative electrode heat-dissipating body 70 may have an insulating body that electrically insulates between the negative electrode lead 55 and the negative electrode tab bundle 22 with which the negative electrode heat-dissipating body 70 comes into contact, and the battery case 80. In addition, in this embodiment, a portion, which includes the case contact surface 68, of the case contact portion 67 of the positive electrode heat-dissipating body 60 is formed from the resistive element 69. However, the resistive element 69 of the positive electrode heat-dissipating body 60 can be absent on the portion including the case contact surface 68, since what is needed is that an electric circuit provided with a resistor is provided between a set consisting of the positive electrode lead 50 and the positive electrode tab bundle 12, and the battery case main body 81 with the positive electrode heat-dissipating body 60.

However, in this embodiment, the thickness of the respective positive electrode contact portions 61a, 61b, and 61c of the positive electrode heat-dissipating body 60 in the Y direction is different in each case, and the thickness of the respective negative electrode contact portions 71a, 71b, and 71c of the negative electrode heat-dissipating body 70 in the Y direction is also different in each case. Therefore, in regard to this reason, description will be made with respect to the positive electrode heat-dissipating body 60 as an example.

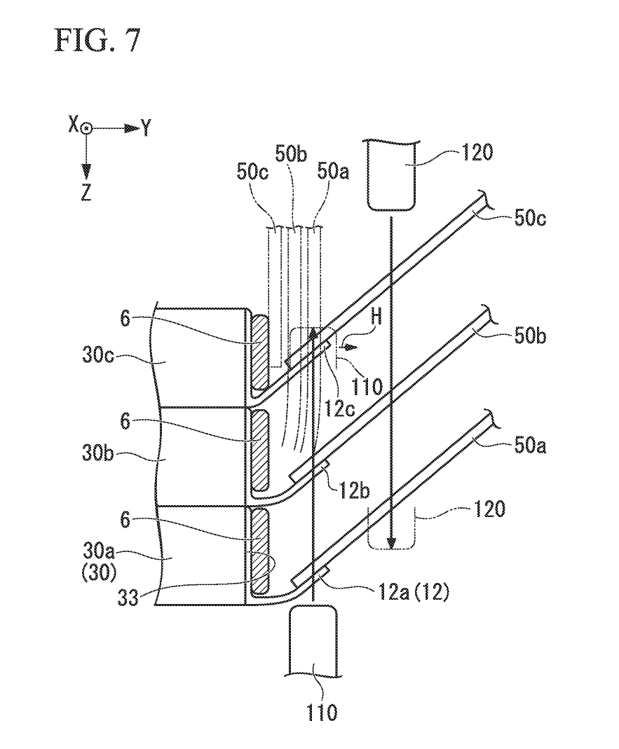

Provisionally, as shown in FIG. 7, the respective electrode contact portions 61a, 61b, and 61c of the positive electrode heat-dissipating body 60 are assumed as tap pressing jigs 6 having the same thickness in the Y direction.

Also, in this case, similarly to the lead-bending process as described above, first, the respective tab bundles 12a, 12b, and 12c of the electrode-stacked bodies 30a, 30b, and 30c are pressed by the tab pressing jigs 6, respectively. Next, the lead-pressing jig 110 is made to move in the (−)Z direction, and the tab connection portions of the leads 50a, 50b, and 50c are brought into contact with corresponding tab pressing jigs 6, respectively, and thus the respective leads 50a, 50b, and 50c face the (−)Z direction. In addition, the lead-bending jig 120 is made to move in the (+)Z direction, and thus leading end sides of the respective leads 50a, 50b, and 50c face the (+)Z direction.

When the respective leads 50a, 50b, and 50c are bent in the above-described sequence, as the lead-pressing jig 110 moves in the (−)Z direction, the number of leads 50a, 50b, and 50c increases, and thus the lead-pressing jig 110 escapes in the lead thickness direction, that is, the (+)Y direction.

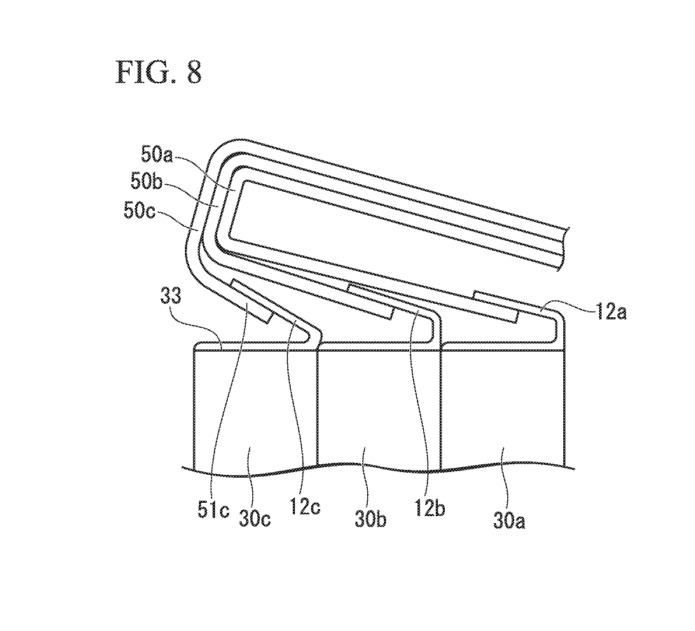

As a result, as shown in FIG. 8, the bending amount of the lead 50c with respect to the electrode-stacked body 30c on the (−)Z side is smaller than that of the lead 50b with respect to another electrode-stacked body 30b that is adjacent to the (−)Z side of the electrode-stacked body 30c, and thus the tab connection portion 51c is inclined with respect to the lead forming end surface 33. Therefore, when the electrode-stacked body 30c vibrates in the Y direction, a corner of the tab connection portion 51c that is inclined comes into contact with a base portion, which extends along the lead forming end surface 33, of the tab bundle 12c with a certain angle, and thus there is a high possibility that tab bundle 12c may be damaged.

Conversely, in this embodiment, as described above with reference to FIGS. 5, 6, and the like, in regard to the thickness of the respective positive electrode contact portions 61a, 61b, and 61c of the positive electrode heat-dissipating body 60, compared to the positive electrode contact portions 61c and 61b on the (−)Z side, other positive electrode contact portions 61b and 61a that are adjacent to the positive electrode contact portion 61c and 61b at the (+)Z side are thicker by a sum of the thickness of the positive electrode tab bundle and the thickness of the positive electrode lead.

Therefore, in the lead-pressing jig 110, during advancing from a retreated position in the (−)Z direction, even when the number of leads 50a, 50b, and 50c that are pressed sequentially increases, and corresponding leads 50a, 50b, and 50c are brought into contact with the lead contact surfaces 63 of the positive electrode contact portions 61a, 61b, and 61c, respectively, since the leads 50a, 50b, and 50c are escaped to the (−)Y side by the thickness of the tab bundle and the thickness of the lead, the leading end side of the lead-pressing jig 110 does not escape to the (+)Y side.

Therefore, in this embodiment, even during moving the lead-bending jig 120 to bend the respective leads 50a, 50b, and 50c, and even after the respective leads 50a, 50b, and 50c are bent, as described above, the tab connection sides of the respective leads 50a, 50b, and 50c enter a state of extending in the (−)Z direction that is the advancing direction of the lead-pressing jig 95.

As described above, since all of the tab connection sides of the respective leads 50a, 50b, and 50c enter the state of extending in the (−)Z direction that is the advancing direction of the lead-pressing jig 110, in this embodiment, even when the electrode-stacked bodies 30a, 30b, and 30c vibrate in the Y direction, the tab connection portions of the respective leads 50a, 50b, and 50c come into contact with base portions, which extend along the lead forming end surface 33, of the tab bundles 12a, 12b, and 12c in a surface contact manner, and thus the tab bundles 12a, 12b, and 12c is not damaged.

### Second Embodiment

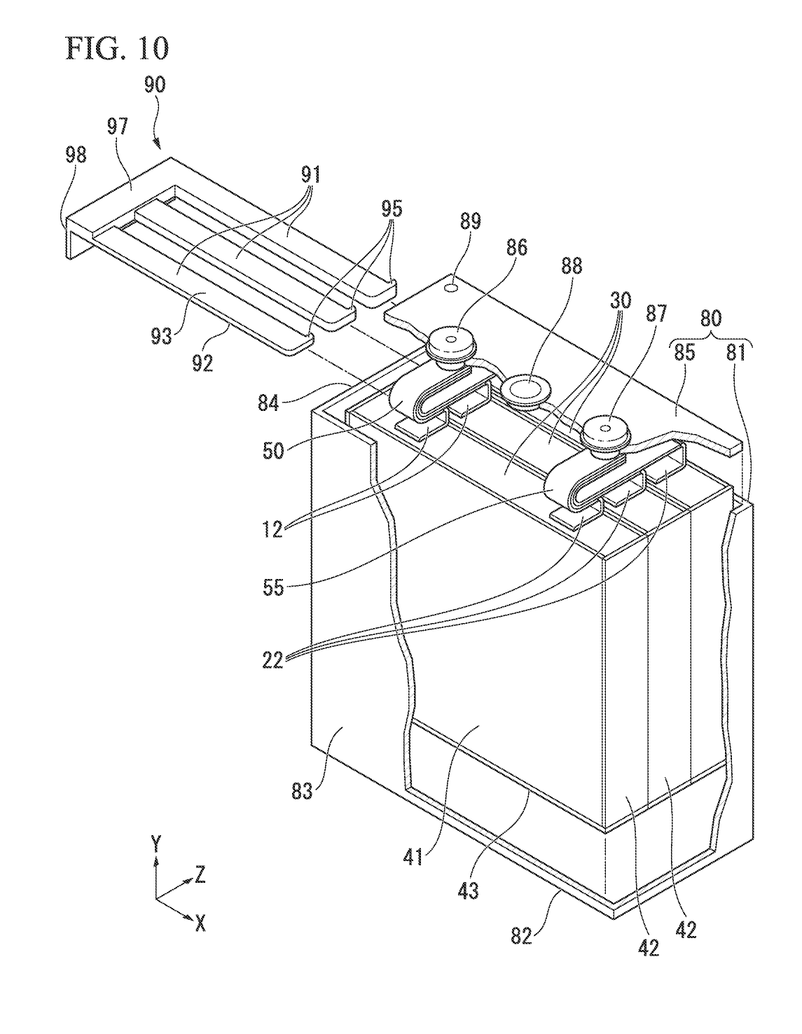

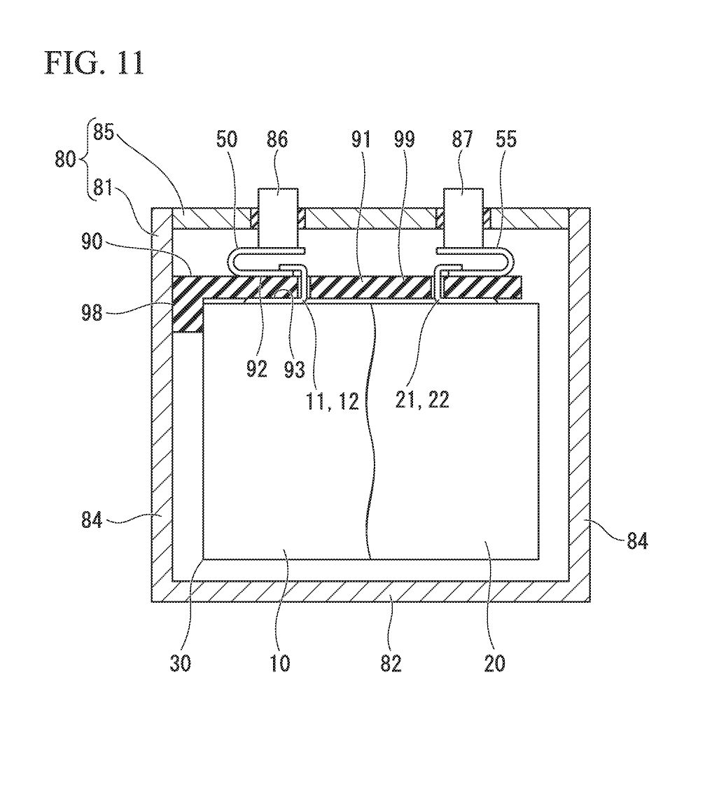

Next, a battery as a second embodiment according to the present invention will be described with reference to FIGS. 10 and 11.

In the battery of this embodiment, the positive electrode heat-dissipating body and the negative electrode heat-dissipating body of the first embodiment are integrally formed to form a positive and negative electrode heat-dissipating body 90, and the other configurations are the same as the first embodiment.

The positive and negative electrode heat-dissipating body 90 includes an electrode contact portion 91 that is formed for each of the electrode-stacked bodies 30, a movement-regulating portion 95 that is provided to one end side of each electrode contact portion 91, and a common case contact portion 97 that connects the other end sides of the electrode contact portions 91 to each other and comes into contact with the inner surface of the battery case main body 81.

The case contact portion 97 has a case contact surface 98 that comes into contact with the (−)X side second side plate 84 of the battery case main body 81.

Each of the electrode contact portions 91 has a pair of surfaces 92 and 93 that extend from the common case contact portion 97 in the (+)X direction and are orthogonal to the Y direction. In the pair of surfaces 92 and 93, a surface that faces the (−)Y side makes up a tab contact surface 92 that comes into contact with the positive electrode tab bundle 12 and the negative electrode tab bundle 22, and a surface that faces the (+)Y side makes up a lead contact surface 93 that comes into contact with the positive electrode lead 50 that is connected to the positive electrode tab bundle 12 and the negative electrode lead 55 that is connected to the negative electrode tab bundle 22.

Each movement-regulating portion 95 protrudes from the (+)X side end portion of each contact portion 91 in the (+)Z direction. The movement-regulating portion 95 forms a hook shape, on which the negative electrode tab bundle 22 is hooked, in cooperation with the electrode contact portion 91 that extends in the X direction.

In regard to the thickness that is the distance between the tab contact surface 92 and the lead contact surface 93 of each electrode contact portion 91 of the positive and negative electrode heat-dissipating body 90, compared to the electrode contact portion 91 on the (−)Z side, another electrode contact portion 91 that is adjacent to the (−)Z side electrode contact portion 91 from the (+)Z side is thicker by the thickness of the tab bundle and the thickness of the lead.

As described above, the positive and negative electrode heat-dissipating body 90 has the same shape as the positive electrode heat-dissipating body 60 except that the length of the electrode contact portion 91 is larger that of the positive electrode contact portion 61 of the positive electrode heat-dissipating body 60 according to the first embodiment in the X direction.

As shown in FIG. 11, the positive and negative electrode heat-dissipating body 90 is formed from an insulating body 99 having high thermal conductivity. In addition, FIG. 11 shows a schematic view of the inside of the battery of this embodiment.

Similarly to the first embodiment, in this embodiment, the positive and negative electrode heat-dissipating body 90 having high thermal conductivity also comes into contact with the respective leads 50 and 55 and the respective tab bundles 12 and 22, and comes into contact with the inner surface of the battery case main body 81. Therefore, heat from the respective leads 50 and 55, and the respective tab bundles 12 and 22 can be effectively transmitted to the battery case main body 81. In addition, similarly to the first embodiment, in this embodiment, the positive and negative electrode heat-dissipating body 90 can be used as a jig during bending the respective leads 50 and 55, the cost for preparing a separate jig can be reduced.

However, in this embodiment, since the entirety of the positive and negative electrode heat-dissipating body 90 is formed from the insulating body 99, the positive electrode lead 50 and the battery case main body 81 may not have the same electrical potential like the first embodiment.

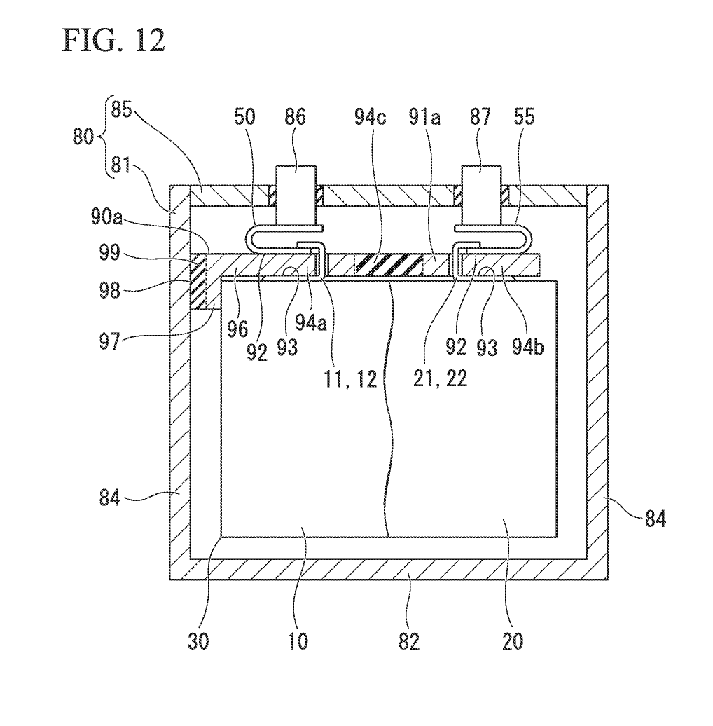

Therefore, to make positive electrode lead 50 and the battery case main body 81 have the same electrical potential with a positive and negative electrode heat-dissipating body, a positive and negative electrode heat-dissipating body 90a may be configured as as shown in FIG. 12. That is, in an electrode contact portion 91a of the positive and negative electrode heat-dissipating body 90a, a portion 94c between a portion 94a that comes into contact with the positive electrode lead 50 and the positive electrode tab bundle 12, and a portion 94b that comes into contact with the negative electrode lead 55 and the negative electrode tab bundle 22 are formed from an insulating material, or the portion 94b that comes into contact with the negative electrode lead 55 and the negative electrode tab bundle 22 may be formed from an insulating material so as not to short circuit between the positive electrode lead 50 and the negative electrode lead 55. In addition, in order for an electric circuit provided with a resistor to be formed between the positive electrode lead 50, the positive electrode tab bundle 12, and the battery case main body 81, in the electrode contact portion 91a of the positive and negative electrode heat-dissipating body 90a, the portion 94a that comes into contact with the positive electrode lead 50 and the positive electrode tab bundle 12 is formed from a conductive body 96, and a portion including a case contact surface 98 is formed from a resistive element 99.

In addition, in the respective embodiments, the thicknesses of the respective electrode contact portions 61, 71, and 91 of the heat-dissipating bodies 60, 70, and 90 in the Y direction are made to be different from each other, but the thicknesses can be the same as each other. However, as described above, from a viewpoint of not damaging tab bundles 12 and 22, like the respective embodiments, it is preferable to make the thickness of the respective electrode contact portions 61, 71, and 91 of the heat-dissipating bodies 60, 70, and 90 different from each other.

In addition, in the respective embodiments, electrode-stacked bodies is provided, however, the invention is not limited thereto.

In addition, in the respective embodiments, the heat-dissipating bodies 60, 70, and 90 are used as a jig during bending the respective leads 50 and 55, but they do not have to be used as a jig.

### INDUSTRIAL APPLICABILITY

The invention relates to a battery including a positive electrode plate and a negative electrode plate, a positive electrode lead that is connected to the positive electrode plate, a positive electrode terminal to which the positive electrode lead is connected, a negative electrode lead that is connected to the negative electrode plate, a negative electrode terminal to which the negative electrode lead is connected, a battery case which stores the positive electrode plate, the negative electrode plate, the positive electrode lead, and the negative electrode lead, and to which the positive electrode terminal and the negative electrode terminal are fixed through an insulating material, a positive electrode heat-dissipating body that has thermal conductivity, and that comes into contact with the positive electrode lead and an inner surface of the battery case, and a negative electrode heat-dissipating body that has thermal conductivity, and that comes into contact with the negative electrode lead and the inner surface of the battery case. According to the invention, the heat dissipation effect of the lead may be increased.

### [Brief Description of the Reference Symbols]

10: Positive electrode plate

11: Positive electrode tab

20: Negative electrode plate

21: Negative electrode tab

25: Separator

30: Electrode-stacked body

41, 42, 43: Cover plate

50, 50a, 50b, 50c: Positive electrode lead

55: Negative electrode lead

60: Positive electrode heat-dissipating body

61: Positive electrode contact portion

62, 72, 92: Tab contact surface

63, 73, 93: Lead contact surface

65, 75, 95: Movement-regulating portion

67, 77: Case contact portion

68, 78: Case contact surface

70: Negative electrode heat-dissipating body

71: Negative electrode contact portion

80: Battery case

81: Case main body

85: Lid

86: Positive electrode terminal

87: Negative electrode terminal

90: Positive and negative electrode heat-dissipating body

91: Electrode contact portion

97: Common case contact portion

100: Table

110, 115: Lead-pressing jig

120, 125: Lead-bending jig

1. A battery comprising:
a positive electrode plate and a negative electrode plate;
a positive electrode lead that is connected to the positive electrode plate;
a positive electrode terminal to which the positive electrode lead is connected;
a negative electrode lead that is connected to the negative electrode plate;
a negative electrode terminal to which the negative electrode lead is connected;
a battery case which stores the positive electrode plate, the negative electrode plate, the positive electrode lead, and the negative electrode lead, and to which the positive electrode terminal and the negative electrode terminal are fixed through an insulating material;
a positive electrode heat-dissipating body that has thermal conductivity, and that comes into contact with the positive electrode lead and an inner surface of the battery case; and
a negative electrode heat-dissipating body that has thermal conductivity, and that comes into contact with the negative electrode lead and the inner surface of the battery case.

2. The battery according to claim 1,
wherein one of the positive electrode heat-dissipating body and the negative electrode heat-dissipating body is formed to have an insulating body that electrically insulates between the lead and the battery case with which the one heat-dissipating body comes into contact, and
the other heat-dissipating body of the positive electrode heat-dissipating body and the negative electrode heat-dissipating body is formed to have a resistive element that serves as an electrical resistor between the lead and the battery case with which the other heat-dissipating body comes in contact, the lead being one of the positive electrode lead and the negative electrode lead, and a conductive body that electrically connects between the lead and the battery case with which the other heat-dissipating body comes into contact.

3. The battery according to claim 2,
wherein at least the inner surface of the battery case is formed from an aluminum-based material, and the inside of the battery case is filled with an electrolyte containing lithium ions, and
the one heat-dissipating body is the negative electrode heat-dissipating body, and the other heat-dissipating body is the positive electrode heat-dissipating body.

4. The battery according to claim 1, further comprising:
a plurality of electrode-stacked bodies that are configured in such a manner that a plurality of the positive electrode plates each having a positive electrode tab, and a plurality of the negative electrode plates each having a negative electrode tab are alternately stacked through a separator,
wherein in the electrode-stacked bodies, a positive electrode tab bundle, which is a bundle of the plurality of positive electrode tabs of the electrode-stacked bodies, and the positive electrode lead are connected to each other, and a negative electrode tab bundle, which is a bundle of the plurality of negative electrode tabs of the electrode-stacked bodies, and the negative electrode lead are connected to each other,
the plurality of electrode-stacked bodies are stacked in a first direction in which the positive electrode plates and the negative electrode plates of the electrode-stacked bodies are stacked,
the positive electrode heat-dissipating body comprises:
a positive electrode contact portion, which has a lead contact surface that comes into contact with the positive electrode lead, for each of the plurality of electrode-stacked bodies; and
a case contact portion that connects the positive electrode contact portions of the plurality of electrode-stacked bodies to each other and comes into contact with the inner surface of the battery case, and
the negative electrode heat-dissipating body comprises:
a negative electrode contact portion, which has a lead contact surface that comes into contact with the negative electrode lead, for each of the plurality of electrode-stacked bodies; and
a case contact portion that connects the negative electrode contact portions of the plurality of electrode-stacked bodies to each other and comes into contact with the inner surface of the battery case.

5. The battery according to claim 4,
wherein the positive electrode contact portion for each of the plurality of electrode-stacked bodies has a tab contact surface that comes into contact with a base portion of the positive electrode tab bundle of the electrode-stacked body, and the lead contact surface of the positive electrode contact portion is a surface opposite to the tab contact surface and comes into contact with the positive electrode lead connected to a leading end portion of the positive electrode tab bundle that is bent to one side in the first direction with respect to the base portion of the positive electrode tab bundle,
the negative electrode contact portion for each of the plurality of electrode-stacked bodies has a tab contact surface that comes into contact with a base portion of the negative electrode tab bundle of the electrode-stacked body, and the lead contact surface of the negative electrode contact portion is a surface opposite to the tab contact surface and comes into contact with the negative electrode lead connected to a leading end portion of the negative electrode tab bundle that is bent to one side in the first direction with respect to the base portion of the negative electrode tab bundle,
the thickness, which is a distance between the tab contact surface and the lead contact surface, of the positive electrode contact portion for each of the plurality of electrode-stacked bodies is larger in the positive electrode contact portion corresponding to the electrode-stacked body locating at an opposite side of the one side than in the positive electrode contact portion corresponding to the electrode-stacked body locating at the one side, and
the thickness, which is a distance between the tab contact surface and the lead contact surface, of the negative electrode contact portion for each of the plurality of electrode-stacked bodies is larger in the negative electrode contact portion corresponding to the electrode-stacked body locating at an opposite side of the one side than in the negative electrode contact portion corresponding to the electrode-stacked body locating at the one side.

6. The battery according to claim 5,
wherein the thickness of the positive electrode contact portion for each of the plurality of electrode-stacked bodies is larger at the positive electrode contact portion corresponding to the electrode-stacked body that is adjacent to the other side of the electrode-stacked body than the positive electrode contact portion corresponding to the electrode-stacked body locating at the one side by a sum of the thickness of the positive electrode lead and the thickness of the positive electrode tab bundle, and
the thickness of the negative electrode contact portion for each of the plurality of electrode-stacked bodies is larger at the negative electrode contact portion corresponding to the electrode-stacked body that is adjacent to the other side of the electrode-stacked body than the negative electrode contact portion corresponding to the electrode-stacked body locating at the one side by a sum of the thickness of the negative electrode lead and the thickness of the negative electrode tab bundle.

7. The battery according to any one of claims 1 to 6,
wherein a movement-regulating portion, which regulates relative movement between the positive electrode lead and the positive electrode heat-dissipating body, is formed in the positive electrode heat-dissipating body, and
a movement-regulating portion, which regulates relative movement between the negative electrode lead and the negative electrode heat-dissipating body, is formed in the negative electrode heat-dissipating body.

8. The battery according to any one of claims 1 to 6,
wherein the positive electrode heat-dissipating body and the negative electrode heat-dissipating body form an integral positive and negative electrode heat-dissipating body, and
the positive and negative electrode heat-dissipating body is formed to have an insulating body that electrically insulates between the negative electrode lead and the positive electrode lead with which the positive and negative electrode heat-dissipating body comes into contact.

9. The battery according to any one of claims 4 to 6,
wherein the positive electrode heat-dissipating body and the negative electrode heat-dissipating body form an integral positive and negative electrode heat-dissipating body, and
the positive and negative electrode heat-dissipating body is formed to have an electrode contact portion at which the positive electrode contact portion of the positive electrode heat-dissipating body and the negative electrode contact portion of the negative electrode heat-dissipating body are connected to each other, a common case contact portion integrating the case contact portion of the positive electrode heat-dissipating body and the case contact portion of the negative electrode heat-dissipating body, and an insulating body that electrically insulates between the negative electrode lead and the positive electrode lead with which the positive and negative electrode of the heat-dissipating body comes into contact.

10. The battery according to claim 8,
wherein a movement-regulating portion, which regulates relative movement between the positive electrode lead and the negative electrode lead, is formed in the positive and negative electrode heat-dissipating body.

11. The battery according to claim 9,
wherein a movement-regulating portion, which regulates relative movement between the positive electrode lead and the negative electrode lead, is formed in the positive and negative electrode heat-dissipating body.
